(19) United States
(12) Patent Application Publication
(10) Pub. No.: US 2022/0233280 A1
(43) Pub. Date: Jul. 28, 2022

(54) DENTAL IMPLANT SYSTEM

(71) Applicant: Grant Dental Technology Corporation, Colorado Springs, CO (US)

(72) Inventors: Aaron C. Bass, Colorado Springs, CO (US); Richard V. Denton, Colorado Springs, CO (US); James C. Grant, Colorado Springs, CO (US); Bradley W. Renehan, Colorado Springs, CO (US); Steven D. Wright, Colorado Springs, CO (US)

(21) Appl. No.: 17/618,819

(22) PCT Filed: May 22, 2020
(86) PCT No.: PCT/US2020/034312

§ 371 Date: Dec. 13, 2021

Related U.S. Application Data
(60) Provisional application No. 62/852,472, filed on May 24, 2019.

(51) Int. Cl. A61C 8/00

(52) U.S. Cl. CPC A61C 8/0078; A61C 8/0069; A61C 8/0093; A61C 8/0018; A61C 8/0068

(57) ABSTRACT

A dental implant assembly (200) configured to be positioned in an osteotomy cavity formed in a patient's jawbone. Abase member (204) of the implant is positioned into the cavity. The base member serves as a platform to secure an abutment member (202) of the implant that in turn receives a dental restoration, such as a crown or denture.

### CROSS-REFERENCE TO RELATED APPLICATION

This application claims priority to U.S. Provisional Patent Application No. 62/852,472, filed May 24, 2019, the disclosure of which is incorporated by reference herein in its entirety. This application is also a continuation—in part of U.S. Ser. No. 15/905,306 filed Feb. 26, 2018 titled “Dental Implant System,” which application is a continuation—in part of U.S. Ser. No. 15/640,351 filed Jun. 30, 2017 titled “Dental Implant System,” which application is a continuation-in-part of U.S. Ser. No. 14/642,565 filed Mar. 9, 2015 titled “Eccentric Dental Implant System,” which application claims the benefit of U.S. Prov. Pat. App. Ser. 61/949,908, filed 7 Mar. 2014, the entirety of each of which is hereby incorporated by reference for all purposes.

### FIELD OF THE DISCLOSURE

A dental implant assembly configured to be positioned in an osteotomy cavity formed in a patient's jawbone. A base member of the implant is positioned into the cavity. The base member serves as a platform to secure an abutment member of the implant that in turn receives a dental restoration, such as a crown or denture.

### BACKGROUND

Implants are a popular way to replace a tooth. Due to their relatively low maintenance and durability, people increasingly prefer implants to bridges or dentures. Nevertheless, there remain significant complications that are the result of using a round implant in a jawbone space that formerly supported a non-round or eccentric tooth, and is therefore undersized in one or more horizontal dimensions in relation to the tooth it would replace. These complications include food impaction, bacteria collection, and excessive stress on bone and implant components.

### SUMMARY

A dental implant that includes an eccentrically-shaped base member and an eccentrically-shaped abutment member. In practice, the base member is fitted to be positioned within an eccentrically-shaped osteotomy box or cavity formed within a patient's jawbone. Following the osteotomy and the insertion of the base member, a pilot hole may be drilled within the jawbone. An abutment member may be fitted to the base member. Some embodiments provide an endosseous implant body positioned through a central passage formed within the base member and the abutment member that is torqued into place to rigidly secure the dental implant assembly to the jawbone. Other embodiments provide the base member press fit or cemented into the patient's jawbone.

There is provided a dental implant assembly, comprising: a base member adapted for placement into an opening in jawbone, wherein the base member comprises (a) elongated parallel sidewalls and curved parallel end walls to define a non-circular external surface shape, (b) an internal cavity, and (c) internal receiving threads; an abutment member adapted for placement into the internal cavity of the base member, wherein the abutment member includes a lower portion, a shoulder, and an upper portion, wherein the lower portion is shaped to correspond to the internal cavity shape of the base member, the upper portion is shaped to receive a dental restoration, the abutment member further comprising an internal channel with internal receiving threads; and a fastener adapted for insertion into the abutment member, wherein the fastener comprises a set of lower threads configured to engage the internal receiving threads of the base member.

A further embodiment provides a dental implant assembly, comprising: a base member adapted for placement into an opening in jawbone, wherein the base member comprises a top perimeter and a bottom perimeter that have equal dimensions to one another, elongated sidewalls and curved end walls to define a non-circular external surface shape, (b) an internal cavity, and (c) internal receiving threads; an abutment member adapted for placement into the internal cavity of the base member, wherein the abutment member includes a lower portion, a shoulder, and an upper portion, wherein the lower portion is shaped to correspond to the internal cavity shape of the base member, the upper portion is shaped to receive a dental restoration, the abutment member further comprising an internal channel with internal receiving threads; and a fastener adapted for insertion into the abutment member, wherein the fastener comprises a set of lower threads configured to engage the internal receiving threads of the base member.

Examples also provide at least a portion of an external surface of the base member includes a plurality of concentric ridges or grooves. The fastener may comprise a series of lower threads. The base may be secured in place with respect to a patient's jawbone via press fitting or via bone glue or bone cement. The end walls may have the same radius of curvature. The elongated side walls may be parallel to one another. The end walls may have differing radii of curvature.

There is also provided a method for implanting a dental implant assembly described herein, comprising creating drill holes a distance D2 from one another using a circular drill bit; joining the created drill holes using a straight drill bit, having a width distance of D1 in order to create an eccentrically-shaped opening in a patient's bone.

In a further method, the steps may include creating drill holes a distance D2 from one another using one or more circular drill bits that correspond in size to the ends walls; joining the created drill holes using a straight drill bit, in order to create an eccentrically-shaped opening in a patient's bone. If the end walls have differing radii of curvature, differently sized drill bits may be used. Either of the above methods may then comprise implanting the disclosed dental assembly in the eccentrically shaped opening.

### DESCRIPTION OF THE DRAWINGS

A further understanding of the aspects of the disclosure may be realized by reference to the following figures. In the figures, similar components or features may have the same reference label. Further, various components of the same type may be distinguished by immediately following the reference label with a second label that distinguishes among the similar components. When only the first reference label is used in the specification, the description is applicable to any one of the similar components having the same first reference label irrespective of whether the second reference label is recited.

FIG. 1 shows a cross-sectional side view of one embodiments of a dental implant.

FIG. 2 shows an exploded view of the implant of FIG. 1.

FIG. 3 shows a side cross-sectional view of one embodiment of a base member having an abutment and an implant body secured therein.

FIG. 4 shows an exploded side plan view of the embodiment of FIG. 3.

FIG. 5 shows a side perspective view of an alternate dental implant assembly described herein.

FIG. 6 shows a front plan view of the dental implant assembly of FIG. 5.

FIG. 7 shows a side cross-sectional view of FIG. 6.

FIG. 8 shows a side plan cross-sectional view of the dental implant assembly of FIG. 5.

FIG. 9A shows a perspective view of a base member of the dental implant assembly of FIG. 5.

FIG. 9B shows a perspective view of an alternate base member with partial ridges.

FIG. 10 shows a top plan view of the base member of FIG. 9.

FIG. 11A shows a front cross-sectional view of the base member of FIG. 9.

FIG. 11B shows a front cross-sectional view of an alternate base member having an internal cavity with tapered walls.

FIG. 11C shows a perspective view of the base member of FIG. 11B, with partial ridges.

FIG. 12 shows a side cross-sectional view of the base member of FIG. 9.

FIG. 13 shows a schematic of various burr cuts that may be made in a patent jawbone in order to receive the dental implant assembly of FIG. 5.

FIG. 14 shows a perspective view of an abutment member of the dental implant assembly of FIG. 5.

FIG. 15 shows a front plan view of the abutment member of FIG. 14.

FIG. 16 shows a side cross-sectional view of the abutment member of FIG. 14.

FIG. 17 shows a front cross-sectional view of an alternate abutment member, having a tapered lower portion.

FIG. 18 shows a bottom plan view of the abutment member of FIG. 14.

FIG. 19 shows a top plan view of the abutment member of FIG. 14.

FIG. 20 shows one embodiment of a fastener that may be used in connection with a dental implant assembly of FIG. 5.

FIG. 21 shows one embodiment of a removal tool that may be used to remove the abutment member from the base member.

FIG. 22A shows a perspective view of an alternate base member having an inward taper at its lower portion.

FIG. 22B shows a front cross-sectional view of the base member of FIG. 22A.

FIG. 23A shows a perspective view of an alternate base member having an inward taper at its lower portion, having ridges along an entire face of its elongated wall.

FIG. 23B shows a front cross-sectional view of the base member of FIG. 23A.

FIG. 24 shows a perspective view of an alternate base member having an inward pinched portion at its lower portion.

FIG. 25A shows a perspective view of an alternate base member having different radii of curvatures at its curved ends, with an inward pinched portion at its lower portion.

FIG. 25B shows a perspective view of an alternate base member having different radii of curvatures at its curved ends, with parallel walls in the same access from the top perimeter to the bottom perimeter.

FIG. 25C shows a schematic of shows various burr cuts that may be made in a patent jawbone in order to receive the dental implant assembly of FIGS. 25A-25C.

### DETAILED DESCRIPTION

When placing a dental implant as discussed throughout, a space or osteotomy cavity is formed in jawbone and then a base member is positioned into the space. In general, the base member serves as a platform to secure an abutment that in turn receives a dental restoration, such as a crown or denture. In one aspect, the outer cross-section of the base member is eccentric in cross-section. The term “eccentric” is used herein to mean non-circular and non-radially symmetric. Eccentric includes “rounded” or “soft” triangular shapes, “rounded” or “soft” rectangular shapes, “rounded” or “soft” square shapes, “rounded” or “soft” trapezoidal shapes, any “rounded” or “soft” polygonal shape, an oval or elliptical shape, or any other appropriate shape. The edges are generally intended to be “rounded” or “soft,” similar to tooth curvatures. Providing an eccentric external cross-section prevents the base member from rotating within bone, due to its eccentric shape. The base member may have a relatively large surface area that is in contact with or integrated into the jawbone, and this decreases stress on the bone, implant, abutment, and crown. In another aspect, the base member has a recess that receives the bottom end of the abutment, which is shaped to match the non-circular and non-radially symmetric geometry of the base member. This provides a precise friction connection for the physician to position the implant within the base in a correct orientation, prevents the abutment from rotating relative to the base member, creates a tight seal, and distributes forces throughout the connected pieces. Certain embodiments may provide an implant body positioned through the base member and the abutment member. Other embodiments use a fastener to secure the base member to the abutment member, but that does not extend through the base member. Other embodiments press fit a base member in an abutment member to one another, without use of a fastener or implant body.

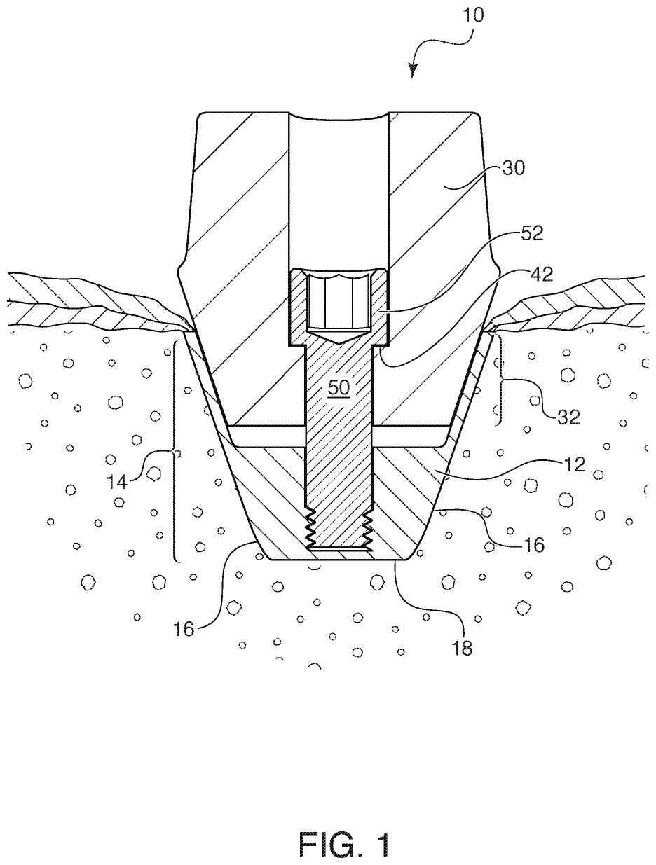

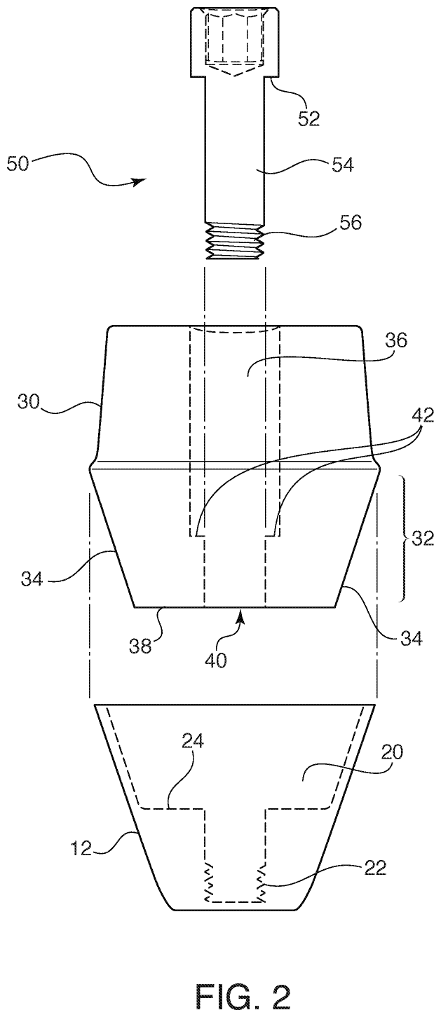

Referring now to FIGS. 1-2, examples of a dental implant 10 are shown and described. As illustrated by FIG. 1, the dental implant 10 may include a base member 12 that is configured to be press fit or cemented into place with respect to a patient's jawbone. The base member 12 may be shaped somewhat as a basket, and is commonly referred to as a “basket” by some physicians. The base member has an eccentric (non-circular) cross section, which can help prevent it from twisting upon application of torque once implanted. The base member 12 has a lower bone-contacting surface 14. The lower bone-contacting surface 14 may define angled side walls 16 and a base wall 18. It is envisioned that angled side walls 16 may help implantation of the base member 12, but it should be understood that straight or parallel walls are possible and considered within the scope of this disclosure, as described further below. The base wall 18 is illustrated as being a solid base without an opening therethrough. Alternate base members configured to receive an implant body are also described further below. This particular embodiment of FIGS. 1 and 2 is designed to be press fit or cemented into place, rather than being secured with a fastener or receiving an implant body.

For press-fitting the base member 12 into place, it is expected that angled side walls 16 may help “wedge” the base member securely in place. The bone-contacting surface 14 may be provided with one or more bone ingrowth/encouraging features, such as ridges, a surface roughness, a bone ingrowth/encouraging chemical or substance, or any combination thereof, all of which can help encourage implantation stability of the base member 12. In other examples, the base member 12 may be cemented into place. Various types of bone glues or bone cements are possible for use herewith. For example, there are bone glues being developed that can set quite quickly, which may allow for the possibility of implanting the dental implant in one sitting. (Whereas currently, as described in more detail below, a base member is typically positioned and then receives a bone screw in order to secure it into place; this configuration is allowed to heal for several months prior to completion of the remainder of the surgery. For example, there is a movement toward immediately inserting the abutment in the same setting, which is in particular possible if fast drying glue or cement are used. This dispenses with the healing cap and tissue former. The presently-described embodiments may be used consistent with this trend. However, it is also possible that once the base member and its accompanying components are implanted, a healing cap and tissue former may be used to allow the base member to heal prior to placement of the implant replacement tooth.)

As shown more clearly in FIG. 2, the interior of the base member 12 defines a cavity 20. Cavity 20 is configured to receive an abutment 30, as described further below. Cavity 20 may be provided with internal screw threads 22. Internal screw threads 22 are configured to receive a fastener 50, as also described further below. It is possible, however, to secure the base member and abutment without the use of internal screw threads or a fastener. The components may directly nest and be glued, cemented, or otherwise adhered to one another.

FIG. 1 also shows an abutment 30 in position within cavity 20 of base member 12. The abutment 30 is configured with a lower portion 32 that nests within cavity 20. The lower portion 32 may have angled sidewalls 34 that closely track the angle and configuration of angled sidewalls 16 of the base member 12. A central channel 36 extends through the abutment 30. The lower surface 38 of the abutment 30 is illustrated as having an opening 40 therethrough. The central channel 36 and the opening 40 are configured to receive an optional fastener 50 for securing the abutment 30 to the base member 12 in use. The central channel 36 may be provided with interior ledges 42 that are configured to support the fastener head 52. A remainder of the abutment body is generally solid material. Although FIG. 1 illustrates space between the base member 12 and the abutment 30, it should be understood that the components may completely nest, with surfaces 38 and 24 contacting one another.

Fastener 50 is illustrated as having a fastener head 52, a shank 54, and lower threads 56. The fastener head 52 is configured to abut the interior ledges 42 when the fastener is in place, as illustrated by the completed assembly 10 of FIG. 1. The lower threads 56 cooperate with the internal screw threads 22 of the base member. FIG. 2 illustrates an exploded view of the base member 12, abutment 30, and fastener 50, prior to their assembly and securement to one another.

Each of the above-described configurations is designed to be press fit or glued or cemented into a patient's jawbone. Each embodiment illustrates a base member with a thickened base wall. The thickened base wall can accommodate a female thread from a fastener that secures the abutment in place. It should be understood, however, that it may be possible to press fit or glue or cement the base member and abutment with respect to one another, removing the need to use fastener 50. Accordingly, it is possible to provide a design that does not include internal screw threads 22 or central channel 36 or interior ledges 42. In other words, the base member and the abutment may directly cooperate with one another without use of a fastener or other securement member.

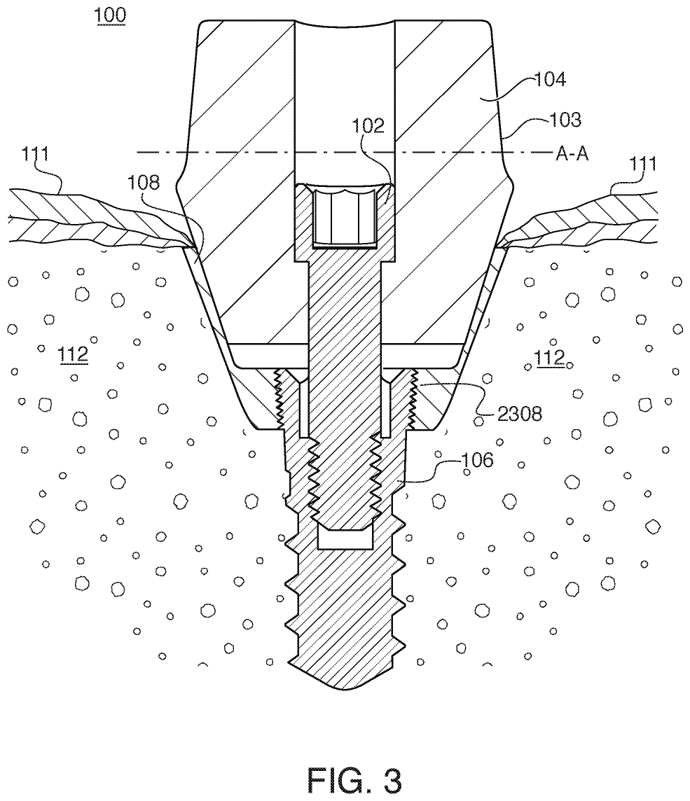

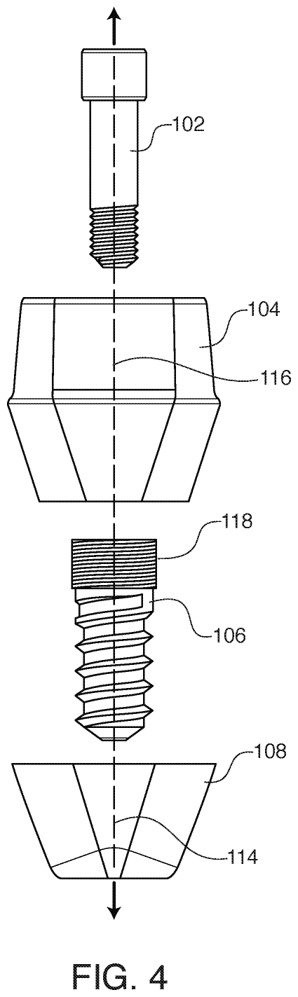

Referring now to FIGS. 3 and 4, an alternate dental implant 100 is shown and described. The dental implant 100 includes or comprises a fastener 102, an abutment member 104, an endosseous implant body 106, and a base member 108. In practice, the base member 108 is fitted to or positioned within an eccentrically-shaped (e.g., oval-like) osteotomy box or cavity 110 formed within jawbone 112, shown in FIG. 3 in exaggerated and simplified view. It is possible for the outer dimensions and shape of the abutment member 104, where it is inserted into the base member 108, to be designed to be closely aligned with the base member dimensions (generally called platform matching), or the outer dimensions of the abutment can be slightly smaller than the base member while generally following the shape of the base member (generally called platform switching). The tissue 111 may be folded back to carry out the osteotomy that is to accommodate the base member 108. This may involve drilling of a small pilot hole within the jawbone 112 for carrying out the osteotomy. Then, the base member 108 may be inserted. A pilot hole is further drilled with base member already in place as a guide, for subsequent insertion of the endosseous implant body 106. The endosseous implant body 106 can be positioned through a central passage 114 (formed along an axis) formed within the base member 108 and then is torqued into place to rigidly secure the base member 108 to the jawbone 112. In some examples, the central passage may be tapered and matches a taper in the head of endosseous implant body 106. In so doing, a friction fit or cold weld is formed between the endosseous implant body 106 and the base member 108 similar to that described in U.S. Pat. Nos. 8,562,244 and 8,740,616, incorporated herein by reference.

In some examples, the central passage 114 includes threads that interact or mate with corresponding threads 2308 in the head of the endosseous implant body 106 to create a tightly sealed connection whereby the endosseous implant body 106 and surfaces of the central passage 114 are cinched tightly together. More specifically, the threaded connection between the endosseous implant body 106 and the base member 108 serves to maintain the friction fit or cold weld between the tapered sections so as to prevent micro-leakages between the two components. Although a threaded connection is shown and described, it should be understood that this connection could also be cemented, cold welded, or use any other appropriate attachment technique. These connections may be used with or without a threaded connection. The abutment member 104 may then be fitted to or positioned within the base member 108. The fastener 102 may then be positioned through an internal passage 116, formed within the abutment member 104 and then may be torqued into place within a receiver 118 formed within the endosseous implant body 106, to rigidly secure the abutment member 104 to the base member 108. The cross-section of the base member 108 is generally non-circular or eccentric in that an outer surface 103 of the abutment member 104, when viewed in cross-section, exhibits a non-circular or eccentric shape.

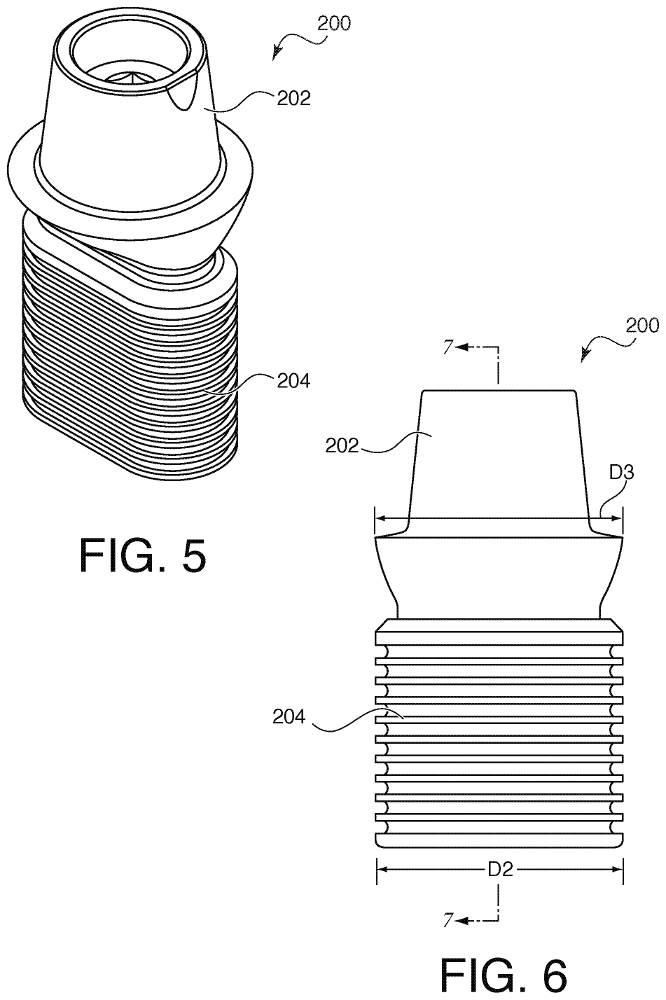

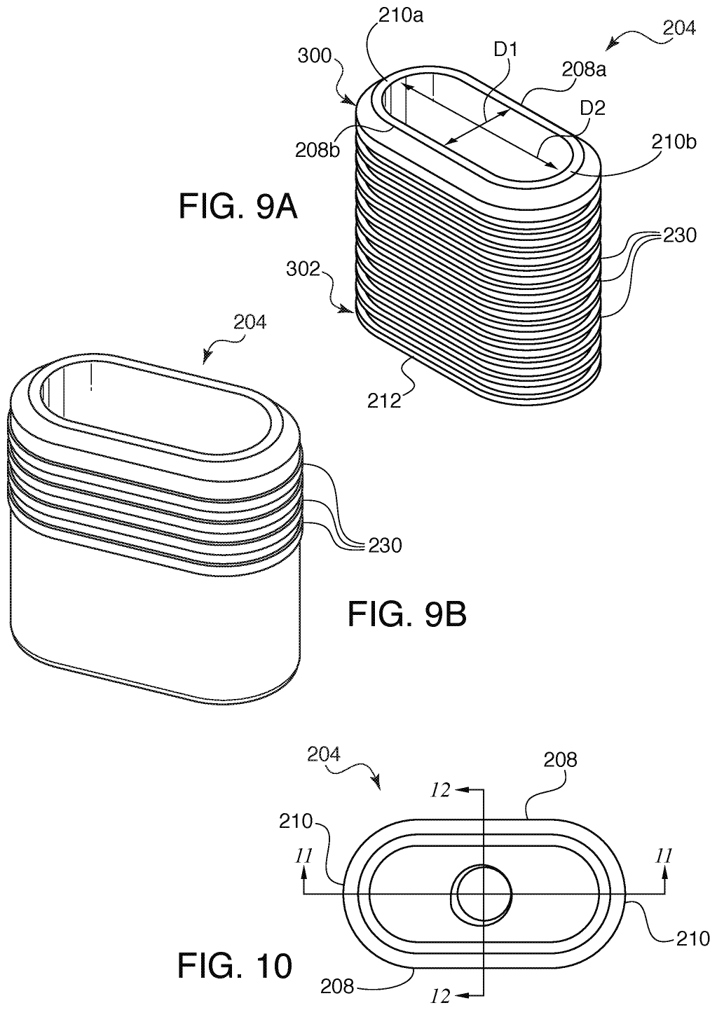

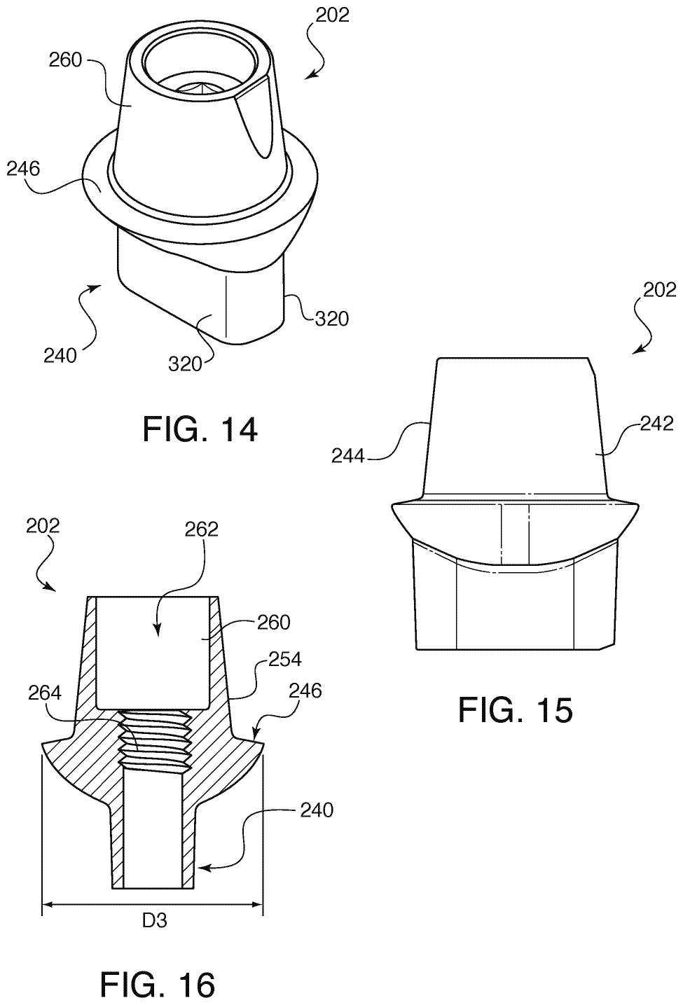

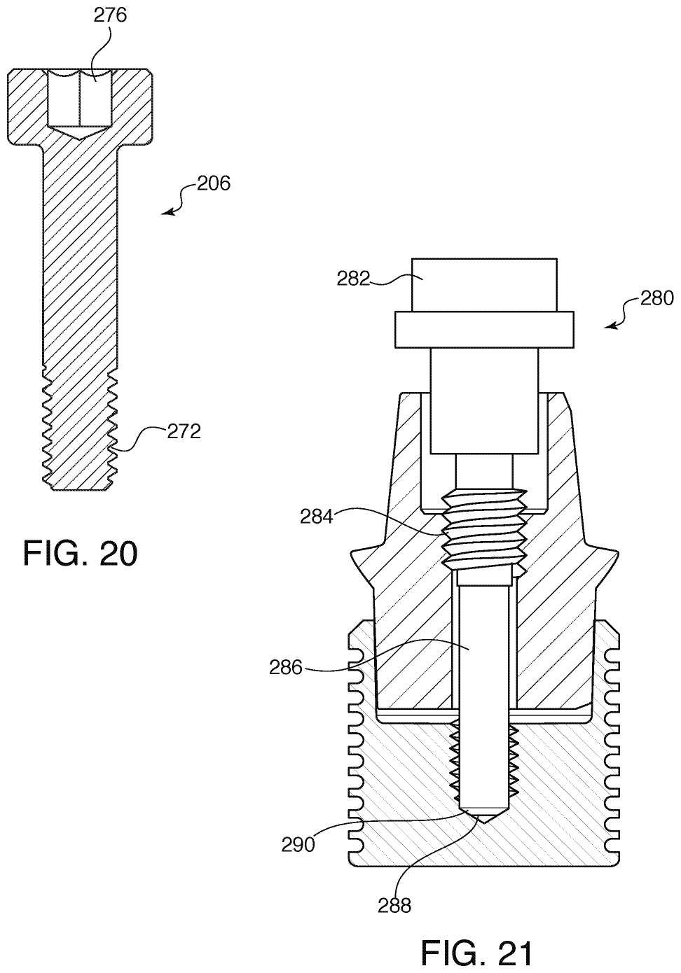

Referring now to FIGS. 5-8, there is shown an alternate dental implant assembly 200. This assembly 200 includes an abutment member 202, a base member 204, and an optional fastener 206. The base member 204 is illustrated in more detail by FIGS. 9-12. The abutment member 202 is illustrated in more detail by FIGS. 14-19. The fastener 106 is illustrated by FIG. 20. A removal tool is illustrated by FIG. 21.

### Base Member

Referring now to the base member 204 shown by FIGS. 9-12, the base member 204 may be configured to be press fit or cemented into place with respect to a patient's jawbone. The base member 204 may be commonly referred to as a “basket” by some physicians. The base member 204 has an eccentric (non-circular) cross section, which can prevent it from twisting upon application of torque once implanted. The base member 204 defines a lower bone-contacting surface for the dental implant assembly 200. The lower bone-contacting surface is illustrated as having substantially parallel elongated side walls 208, curved end walls 210, and a base 212.

As is shown by the perspective view of FIGS. 9A and 9B and the top plan view of FIG. 10, the base member 204 has a non-cylindrical shape. This non-circular shape may be envisioned as being created by the following steps: longitudinally bisecting a cylinder, then moving the two resultant half-cylinders apart by some measurement that may vary, then filling the intervening gap with material to seamlessly bond the two sides together. For example, as shown by FIG. 9, there are two elongated side walls 208a, 208b, separated a distance D1 from one another. The elongated side walls 208a, 208b are substantially parallel to one another. The elongated side walls 208 are each bounded at the end by curved end walls 210a, 210b. The two curved end walls 210a, 210b, separated a distance D2 from one another. Although referred to as separate “walls,” it should be understood that the base member 204 is formed as a seamless, integral component. Its oblong, non-cylindrical shape prevents it from twisting within the patient's bone cavity upon application of torque by an oral surgeon or other practitioner. This resultant shape exhibits semicircular profiles defined by curved end walls 210 at the ends with parallel elongated side walls 208 connecting the ends. FIG. 9A shows ridges 230 (described further below) that extend the entirety of the outer surface of the base member 204. FIG. 9B shows ridges 230 that only cover an upper portion of the base member. Although not shown, it should be understood that ridges may extend only along a lower portion of the base member, they may be sporadic along the outer surface, or no ridges need be present at all. All options and variations thereof are considered within the scope of this disclosure.

In one embodiment, the base member 204 may exhibit surfaces on all sides that are aligned parallel to a longitudinal axis 214. The side walls 208 may be straight, parallel side walls. (Although referred to as “parallel,” it should be understood that some degree of manufacturing tolerances should be considered within the scope of this term. It is possible that a slight taper may be present within the walls. To an ordinary observer, the walls 208 will appear substantially parallel to one another, and walls 210 will appear substantially parallel to one another.) It is envisioned that straight or parallel side walls (while maintaining the eccentric shape of the basket when viewed from a top down perspective), can further increase the bone-contacting surface of the base number 204. This increase in bone-contacting surface can enhance overall implant stability and improve the osseointegration process. Moreover, providing parallel walls 208, 210 can be more conducive to performing a straightforward osteotomy.

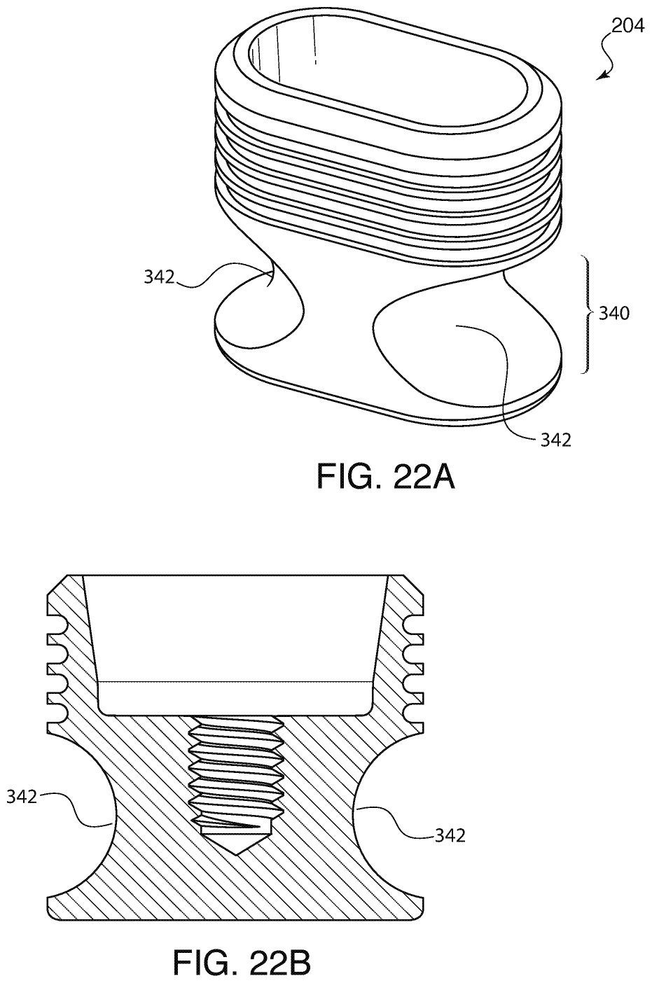

Additionally or alternatively, the walls 210 need not be parallel. If the walls 210 are not parallel to one another, then the top perimeter 300 of the base member 204 should match the bottom perimeter 302 of the base member 204. In other words, the disclosure does not require straight parallel walls, but that the overall implant assembly 200 fits vertically within the osteotomy that is shaped according to the above description. As long as the bottom perimeter 302 of the implant conforms to the prepared osteotomy shape and the top perimeter 300 of the implant conforms to that same shape, the areas in between (vertically) the top and bottom perimeters may be pinched inward, angled inward, concave, wavy, or be provided in any other configuration or shape without compromising the advantages of the design. (Although it should be understood, however, that the areas in between top and bottom perimeters 300, 302 should not bow outward in any fashion, because that would prevent the overall implant assembly 200 from fitting within the specific geometry of the osteotomy as described.) Examples of these options are illustrated by FIGS. 22-24. considered within the scope of this disclosure.

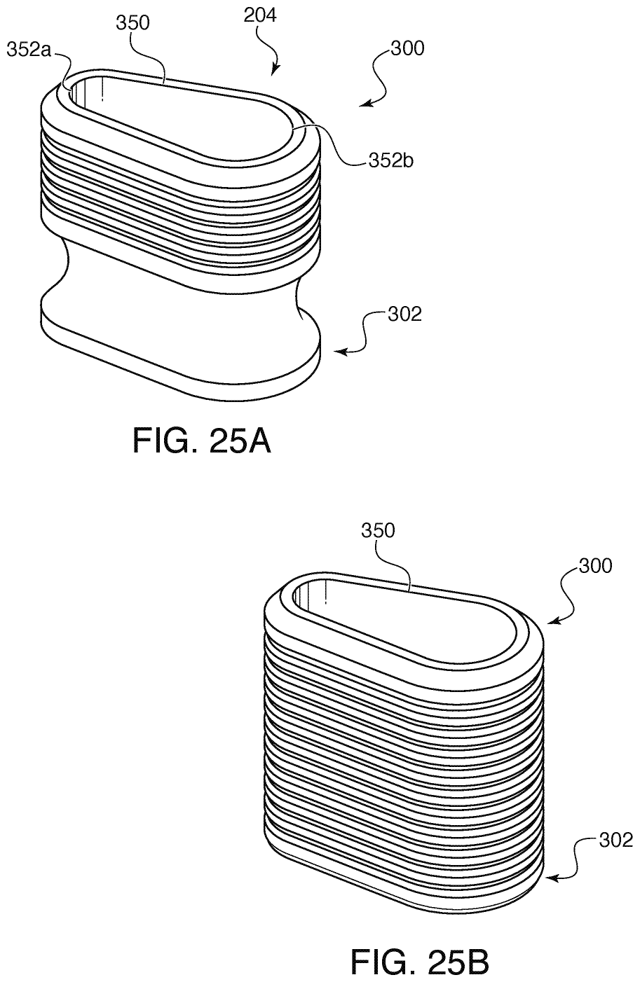

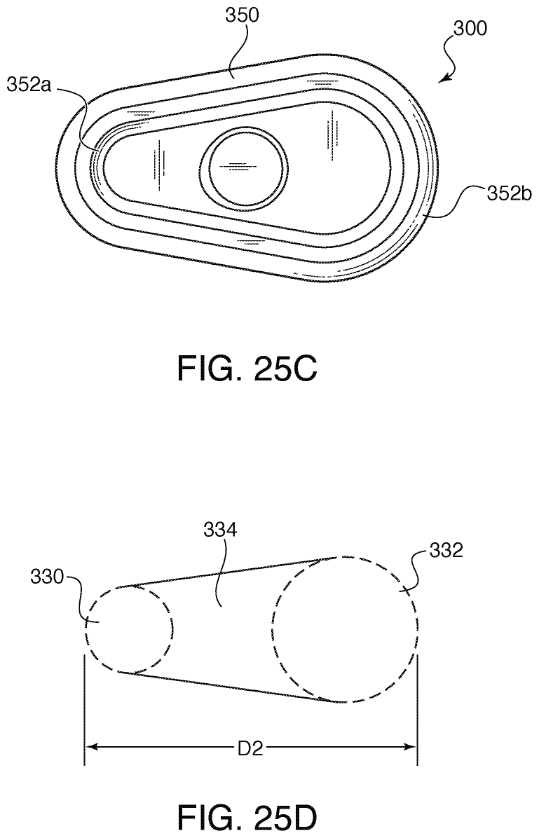

Alternatively, FIGS. 25A-25D illustrate an alternate embodiment in which the top perimeter 300 and the lower perimeter 302 of the base member 204 match. In this embodiment, the elongated side walls 350 are not parallel to one another because the end walls 352 do not share the same radius of curvature. In the examples shown, end wall 352a has a smaller radius of curvature than end wall 352b. The openings formed in the patient's bone to receive these differently sized end walls 352a, 352b may be created using differently sized drill bits or burrs, as described in more detail below. The different radii of curvature because the elongated walls 350 to taper away from one another as they reach curved end wall 352b. However, because the walls 350 define the same consistent shape along the perimeter of the implant, as illustrated by the top plan view of FIG. 25C, the top perimeter 300 has the same shape as the bottom perimeter 302.

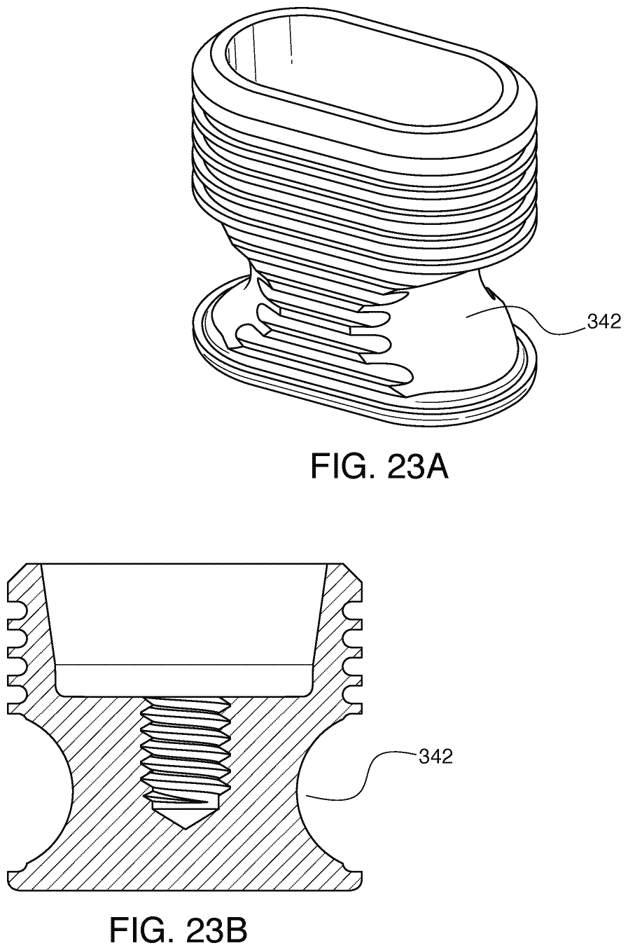

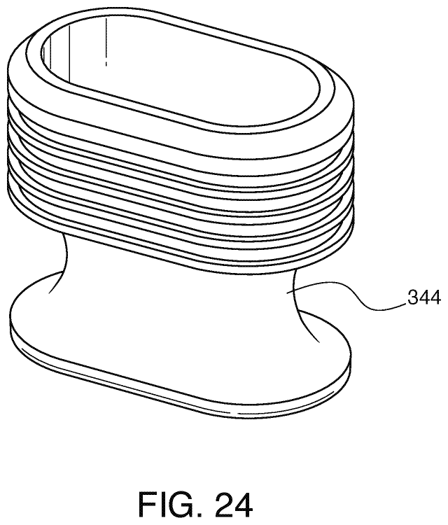

FIGS. 22A and 22B illustrate alternative options of symmetrical top and bottom perimeters 300, 302. In this example, the lower portion 340 of the base member 204 illustrates an inward taper 342 at the location of curved side walls. The elongated side walls feature an upper ribbed portion and a lower un-ribbed portion. FIGS. 23A and 23B illustrate a similar inward taper 342, but show that the elongated side walls may exhibit a ribbed portion along its entire surface. Although not illustrated, it is also possible for the ribbed portion to extend into the inward taper 342 areas. FIG. 24 illustrates that a complete internal pinch 344 may also be an option. In all of these examples, the top perimeter 300 and the lower perimeter 302 all match in size. This allows the dental implant assembly 200 to be positioned into the shaped bone, methods for which are described below.

For example, in prior art implants that had a circular base, a practitioner would drill a receiving opening in the patient's bone sized to receive the circular base. Because prior art implants had a circular base, the base was positioned directly into the circular receiving opening created by the drill. The disclosed base member 204 may be implanted similarly, with minor modifications. Drilling steps are illustrated by FIG. 13.

For example, because there is no drill designed to create an oblong opening within a patient's bone, a plurality of drill bits may be used in order to create the appropriately shaped opening 220. For example, the opening to receive the semicircular end walls may be created using circular drill bits or burrs. In one example, such circular drill bits may be trephine drills or burrs. The burr selected is sized to match the curvature of the curved end walls 210a, 210b. In one example, these circular openings are illustrated as reference numerals 216 in FIG. 13. These openings 216 are generally drilled so that the opposite ends of the opening are a distance of about D2 from one another (or slightly smaller if the dental implant assembly is to be press fit into place). Because these openings 216 will ultimately be connected, the relevant portion drilled is the outer half circle or semicircle shaped to receive the curved end wall 210. Additionally, in the embodiments in which the elongated side walls 208 are parallel to one another, and the curved end walls 210 have the same radius, the same sized drill bit or burr may be used to prepare the openings 216.

However, in embodiments in which the elongated side walls 350 are not parallel to one another and the curved end walls 352 have different radii, as illustrated by FIGS. 25A-25D, different sized drill bits or burrs may be used to prepare these openings. For example, referring to FIG. 25D, a first drill bit size may be used to create opening 330 and a second drill bit size may be used to create opening 332.

Regardless of how the end wall openings are created, next, a straight wall burr may be used to connect the two openings 216 (or 330, 332). The trench or channel created is represented by reference 218 in FIG. 13. This channel 218 is generally drilled so that opposite walls are a distance of about D1 from one another (or slightly smaller if the dental implant assembly is to be press fit into place). The collective drilling steps create the oblong, eccentric, or otherwise noncircular opening 220 illustrated by FIG. 13. This opening 220 is thus sized and shaped in order to receive the base member 204 of FIGS. 9-12. The opening 220 has parallel side walls and curved end walls that correspond to elongated side walls 208 and curved end walls 210 of the base number 204.

Referring now to FIG. 25D, the channel 334 may also drilled so that the openings are a distance D1 from one another. However because the openings 330, 332 in this embodiment are sized differently, the channel may have outwardly tapering walls, matching the outwardly tapering elongated walls 350 of the base member of FIGS. 25A-25C. In both methods illustrated by FIGS. 13 and 25D, the resulting opening created in the patient's bone is sized to receive an appropriate base member 204. Whichever base member 204 is used, it should be understood that the top perimeter 300 and the bottom perimeter 300 are the same shape as the osteotomy created.

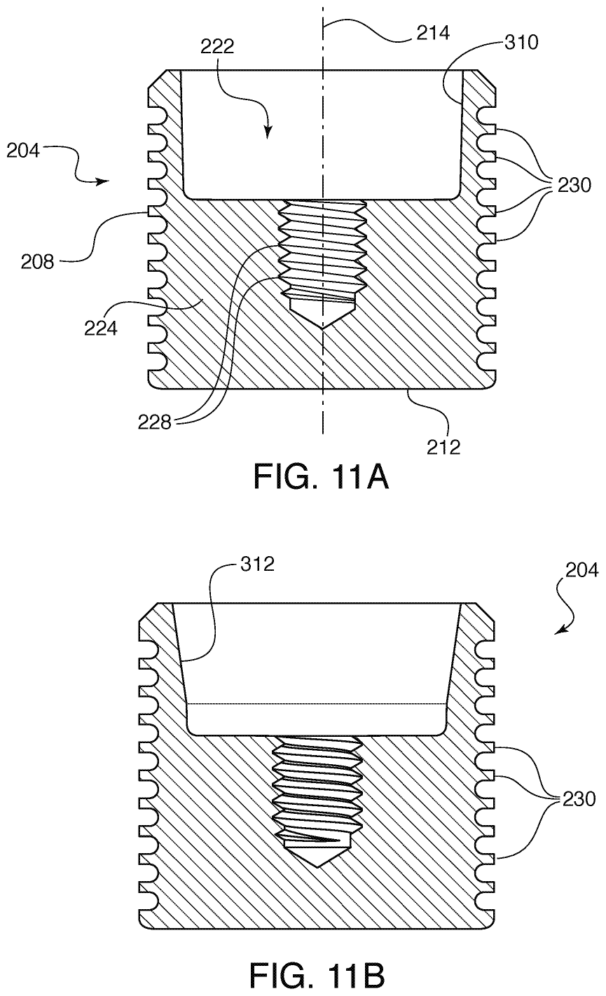

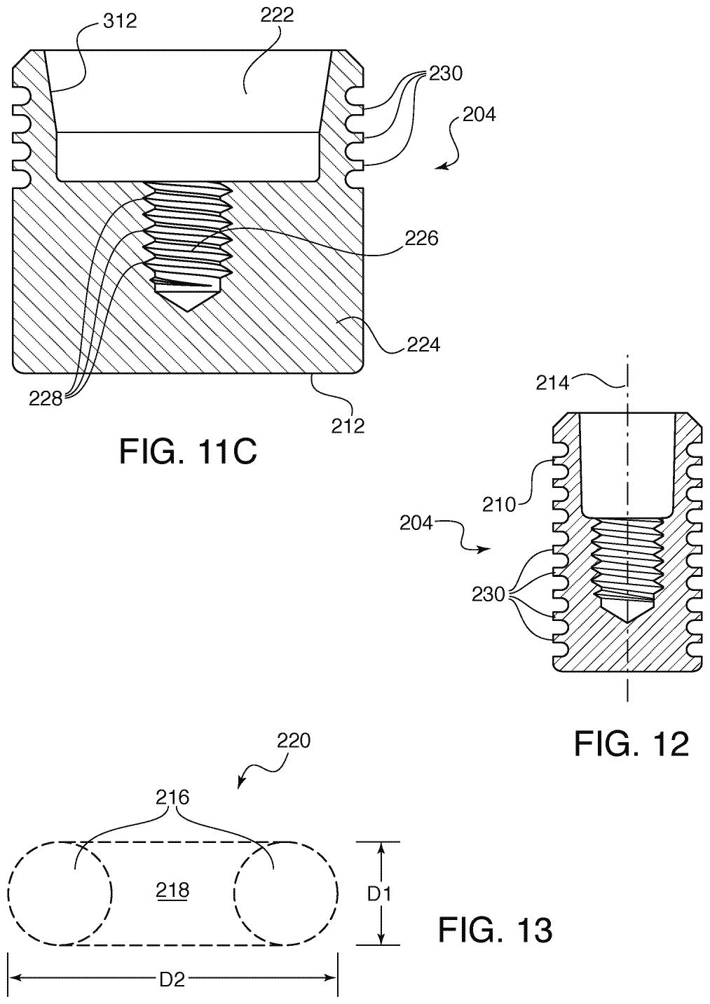

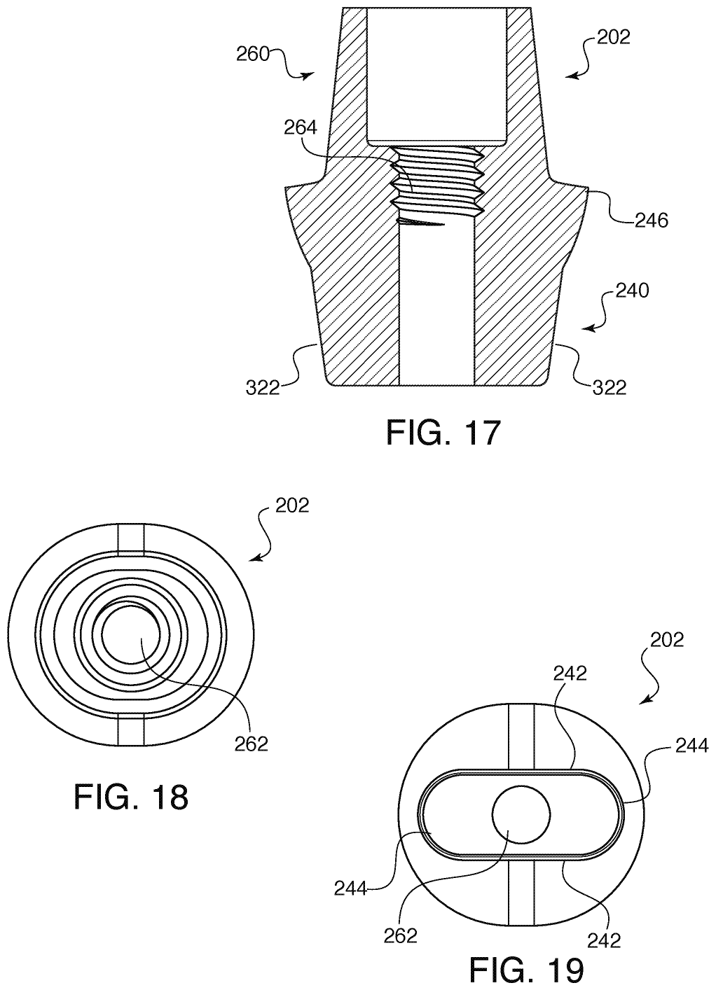

Referring now to FIGS. 11A and 11B, it can be seen that the base member 204 has an internal cavity 222. This internal cavity 222 is sized to receive the abutment member 202, described further below. As shown by FIG. 11A, if the abutment member has a lower portion with parallel walls 320 (as shown by FIGS. 14-16), the cavity 222 may have corresponding internal parallel walls 310. As shown by FIG. 11B, if the abutment member has a lower portion with tapered walls 322 (as shown by FIG. 17), the cavity 222 may have corresponding internal tapered walls 312. A lower portion of the base member 204 may be solid material 224. Extending into solid material 224 is a receiving channel 226. As shown and in specific embodiments, the receiving channel 226 may have internal threads 228 that correspond to and receive threads 272 on the fastener 206 (shown by FIG. 20 and also described further below). The base 212 of the base member 204 is illustrated as being a solid base 212 without an opening therethrough. Such an embodiment may be designed to be press fit or cemented into place, rather than being secured with a securement member. Alternate base members, however, may be configured with a threaded channel that extends completely through the base that can receive an elongated fastener, which can function as a securement member. These embodiments of base members may thus have a base opening extending through the base 212 for receiving the securement member.

The base member 204 is also illustrated as having a plurality of external grooves or ridges 230 along its outer cross-section. It should be understood that various ridge shapes and sizes are possible and considered within the scope of this disclosure. In one example, the ridges 230 may be stepped ridges. In other examples, the ridges 230 may define a variety of square or triangular staircase-like configurations, which includes soft or rounded versions of these configurations. The ridges 230 may improve bone integration by providing increased surface area and distribution of stress/load. The ridges 230 may be surface treated. Such surface treatments may be in addition to or instead of the external ridges 230. In one example, ridges 230 and/or the external surface of the base member 204 may have a micro blasted or etched surface in order to encourage bone on-growth. These surface treatments may help improve bone integration. This may be accomplished in a number of ways. One example includes additive processes, such as plasma spraying or other types of coating. Another example includes subtractive processes, such as acid-washing or bead blasting. A further surface treatment that is possible includes a layer of polyether ether ketone (PEEK) applied to the external surface area in contact with bone. The ridges or grooves may be applied to the entire outer surface, as shown by FIG. 11A. The ridges or grooves may only be applied to a portion of the outer surface, as shown by FIG. 11B.

### Abutment Member

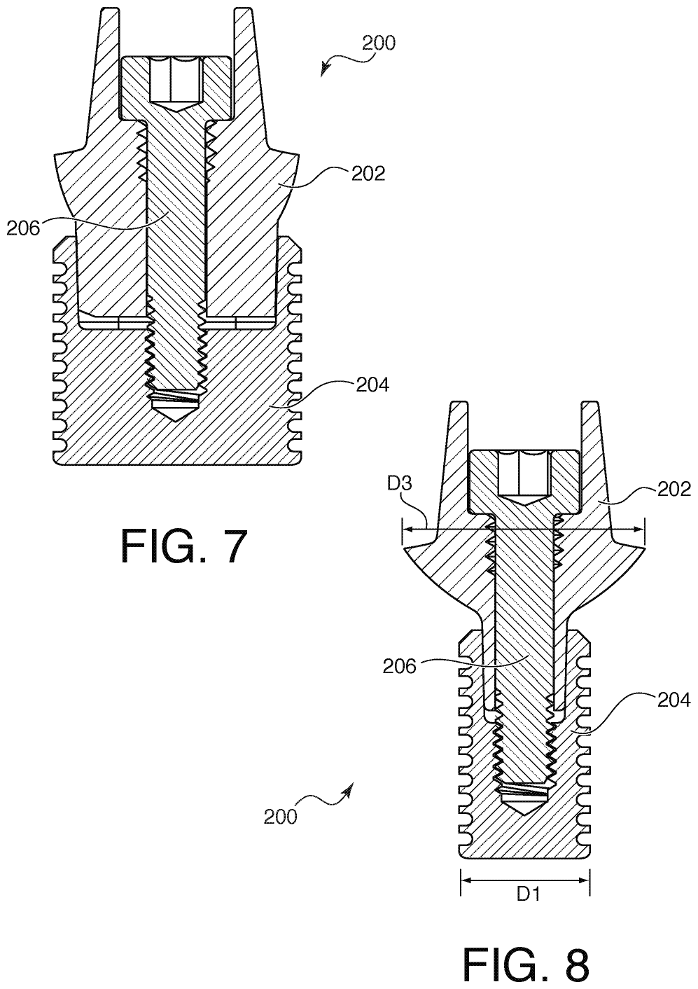

In addition to the base member, the disclosed dental implant assembly 200 also provides an abutment member 202 that functions in cooperation with the base member 204. FIGS. 14-19 illustrate various views of an exemplary abutment member 202. As shown by the cross-sectional views of the assembled dental implant assembly 200 FIGS. 7 and 8, the abutment member 202 may nest or otherwise fit within the internal cavity 222 of the base member 204. Specifically, the abutment member 202 has a lower portion 240 with elongated side walls 242 and curved end walls 244, both of which have outer surfaces that correspond to inner surfaces of the elongated side walls 208 and curved end walls 210 of the base member 204. In use, the lower portion 240 of the abutment member 202 is positioned within the internal cavity 222 of the base member 204. This positioning may be accomplished by a press fit, friction fit (with very slight internal tapers of one or more of the walls 208, 210, 242, and/or 244) such that the abutment member 202 may be securely positioned into place with respect to the base member 204. (A fastener 206 may also be used in order to secure abutment member 202 and base member 204 to one another, described further below.) The abutment member 202 of FIGS. 14-16 has parallel walls 320 at its lower portion 240. The abutment member 202 of FIG. 17 has a slight taper to the walls 322 at its lower portion 240. The internal walls 310, 312 of the cavity 122 of the base member 204 will thus be shaped accordingly.

The abutment member 202 is also shown as having an upwardly curved shoulder 246. This upwardly curved shoulder 246 has a first elongated dimension D3 that is generally similar in length to the distance D2 between the curved end walls 210 of the base member 204. In other words, the shoulder 246 does not extend past the profile of the curved end walls 210. This is illustrated by FIGS. 6 and 7. Upwardly curved shoulder 246 D3 is larger in length than the distance D1 between elongated side walls 208 of the base member 204. In other words, the shoulder 246 does extend past the profile of the elongated side walls 208. This is illustrated by FIG. 8. This extended portion of the shoulder 246 can rest against tissues of the opening created in the patient's bone.

An upper surface 252 of the shoulder 246 has an inward taper 254. This inward taper 254 is shaped as illustrated by FIG. 16, and extends up to form upper portion 260 of the abutment member 202. The upper portion 260 is shaped and configured to support a dental restoration such as crown, not shown in the figures provided.

Extending through the entirety of the abutment member 202 is an internal channel 262. As illustrated by FIGS. 16 and 19, dimensions of the internal channel 262 may have a larger circumference at the upper portion 260 and a smaller circumference at the lower portion 240. This can allow seating of the fastener head 276. At least a portion of the internal channel 262 is provided with receiving threads 264. Receiving threads 264 are provided in order to allow the removal tool (shown by FIG. 21 and described further below) to work properly. The removal tool 280 engages its threads 284 within the abutment. The bottom of the removal tool is smooth (no threads) and is designed to push against the bottom of the threaded well within the base member. As the removal tool is torqued into the threads 264 in the abutment, the bottom of the tool eventually contacts the bottom of the well in the base member and pushes against it. This pops the abutment up without delivering force into the bone that is holding the base member.

The dimensions shown in the below images are for illustrative purposes only. Actual dimensions will vary depending upon patient tooth size and other manufacturing considerations.

In some examples, the implant (buccal lingual) width is from about 3 mm to about 7 mm. In specific examples, the implant width is about 4 mm. Meanwhile the implant mesial distal dimension can range from 4 mm to about 11 mm, with the specific dimensions in the drawings being 7.6 mm.

It is understood that this description is to provide a conceptual understanding, which does not exclude a variety of other non-circular shapes that could be manufactured. In one implementation, only the lower portion 240 of the abutment is non-circular to match the shape of the implant, whereas the abutment shoulder 246 and upper portion 260 can be round or otherwise have a shape that does not correspond to the lower post shape. Within that overall concept, all dimensions and angles (such as the upper portion of the abutment) can vary. The platform switching design for the disclosed dental implant assembly 200 can have a variety of shapes. The general platform switching concept is that the abutment lower portion 240 is “inset” from the outer perimeter of the upper portion 260 (as illustrated by FIG. 15), and the abutment can therefore accommodate a variety of shapes, only one of which shape is shown in the implant drawings. The abutment shoulder chamfer 246 (which may also be referred to as the “abutment shelf” or shoulder) can also vary. Generally, non-angled abutments are shown, but it is understood that angled abutments are considered within the framework of the invention (and are described and shown in the parent applications, incorporated herein by reference).

### Fastener

A fastener 206 or retaining screw may also be provided. One exemplary fastener 206 is illustrated by FIG. 20. If provided, this fastener 206 can also vary in size. Internal screw threads 228 within the base member 204 are configured to receive threads 272. A fastener head 276 may be seated with respect to an internal surface of the abutment, as illustrated by FIGS. 7 and 8. Once the abutment member 202 is placed with respect to the base member 204, the fastener 206 may be torqued into place in order to secure abutment member 202 to the base member 204. The fastener also serves to help prevent any shifting of the abutment member 202 that may otherwise compromise the contacts between the abutment member 202 and base member 204. The fastener 206 prevents concentration of stress forces into small areas. Instead, it assures firm contacts comprising larger force transmission areas and reducing the likelihood of device failure associated with high force concentrations. Additional features of the fastener 206 are shown and described by the parent applications, incorporated herein by reference. (Note that some of the parent applications referred to the fastener as an implant body.)

### Removal Tool

FIG. 21 illustrates a removal tool 280 that may be used to remove the abutment member 202 from the base member 204. The receiving tool may have a head 282 that can receive a driver. Threads 284 may be positioned along a shank 286. The threads 284 may engage with the receiving threads 264 of the abutment member 202. A lower bottom surface 288 of the tool 280 is provided with smooth radii 290 that follow the angle of the drill tip to help guide the shank 286. As described above, the removal tool 280 engages its threads 284 within the abutment. The bottom of the removal tool is smooth (no threads) and is designed to push against the bottom of the threaded well within the base member. As the removal tool is torqued into the threads 264 in the abutment, the bottom of the tool eventually contacts the bottom of the well in the base member and pushes against it. This pops the abutment up without delivering force into the bone that is holding the base member.

As may be understood from the foregoing, a dental implant assembly is disclosed whereby an eccentrically-shaped osteotomy cavity is formed in jawbone and then an eccentrically-shaped base member of the implant is positioned into the cavity. The base member serves as a platform to secure an eccentrically-shaped abutment member of the implant that in turn receives a dental restoration, such as a crown or denture. Advantageously, such an implementation may make it easy for a physician to slip the abutment member into the base member with a correct or proper orientation, and also prevent the abutment member from rotating with respect to the base member due to the complementary oblong or oval geometry of these pieces. Additionally, various features of the pieces or parts of the dental implant may be surface treated in order to improve bone integration and in general fit together with precision.

Furthermore, certain parts or mating areas such as between eccentric surfaces of the abutment member 202 and the base member 204, and surfaces between the base member 204 and the fastener 206, may utilize a very slightly tapered angle so the parts may “cold weld” to tightly lock the pieces together. Advantageously, this may distribute forces more evenly across two pieces, and can also create a seal at a joint to prevent bacterial micro-leakage.

It should be understood that this disclosure relates to components that may be used with various jaw sizes. For example, the base member, the abutment member, and/or the fasteners described herein may have any appropriate diameter, length, taper, or any other dimensions or geometries that allow the system to be used with various jaw sizes. It should be understood that the disclosure may be sized down for use with children and/or sized up for use with particularly large jaw sizes, and by implication, including the full range of tooth sizes from molars to front teeth.

Additionally, although multiple components are described for use in cooperation with one another, it should be understood that it is possible to provide one piece version of the disclosed implant that may be pressed into the pre-drilled osteotomy and into the bone, rather than requiring screws and a multipart implant. In certain embodiments, a one-piece press fit implant having the outer eccentric shapes described herein, may be useful. A one-piece press fit implant may be used for both anterior and posterior teeth. Various sizes are possible and considered within the scope of this disclosure.

The implants disclosed herein may be manufactured using any appropriate methods. In certain examples, powdered metal sintering using 3-D Selective Laser Sintering or SLS printing as possible. The implants disclosed herein may be made of any appropriate biocompatible materials.

A dental implant system or assembly and a method for implanting the same are contemplated and claimed and, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Additionally, the methods, systems or assemblies as discussed above are examples. Various configurations may omit, substitute, or add various method steps or procedures, or components as appropriate. For instance, in alternative examples, the methods may be performed in an order different from that described, and/or various stages may be added, omitted, and/or combined.

1. A dental implant assembly comprising:
a base member adapted for placement into an opening in jawbone, wherein the base member comprises (a) elongated parallel sidewalls and curved parallel end walls to define a non-circular external surface shape, (b) an internal cavity, and (c) internal receiving threads;
an abutment member adapted for placement into the internal cavity of the base member, wherein the abutment member includes a lower portion a shoulder, and an upper portion, wherein the lower portion is shaped to correspond to the internal cavity shape of the base member, the upper portion is shaped to receive a dental restoration, the abutment member further comprising an internal channel with internal receiving threads; and
a fastener adapted for insertion into the abutment member, wherein the fastener comprises a set of lower threads configured to engage the internal receiving threads of the base member.

2. A dental implant assembly, comprising:
a base member adapted for placement into an opening in jawbone, wherein the base member comprises a top perimeter and a bottom perimeter that have equal dimensions to one another, elongated sidewalls and curved end walls to define a non-circular external surface shape, (b) an internal cavity, and (c) internal receiving threads;
an abutment member adapted for placement into the internal cavity of the base member, wherein the abutment member includes a lower portion, a shoulder, and an upper portion, wherein the lower portion is shaped to correspond to the internal cavity shape of the base member, the upper portion is shaped to receive a dental restoration, the abutment member further comprising an internal channel with internal receiving threads; and
a fastener adapted for insertion into the abutment member, wherein the fastener comprises a set of lower threads configured to engage the internal receiving threads of the base member.

3. The dental implant assembly of claim 1, wherein at least a portion of an external surface of the base member includes a plurality of concentric ridges or grooves.

4. The dental implant assembly of claim 1, wherein the fastener comprises a series of lower threads.

5. The dental implant assembly of claim 1, wherein the base member is secured in place with respect to a patient's jawbone via press fitting.

6. The dental implant assembly of claim 1, wherein the base member is secured in place with respect to a patient's jawbone via bone glue or bone cement.

7. The dental implant assembly of claim 1, wherein the end walls have the same radius of curvature.

8. The dental implant assembly of claim 1, wherein the end walls have differing radii of curvature.

9. A method for implanting the dental implant assembly of claim 1, comprising:
creating drill holes a distance D2 from one another using a circular drill bit;
joining the created drill holes using a straight drill bit, having a width distance of D1 in order to create an eccentrically-shaped opening in a patient's bone.

10. A method for implanting the dental implant assembly of claim 1, comprising:
creating drill holes a distance D2 from one another using one or more circular drill bits that correspond in size to the ends walls;
joining the created drill holes using a straight drill bit, in order to create an eccentrically-shaped opening in a patient's bone.

11. The method of claim 10, wherein the end walls have the same radius of curvature and the elongated walls are parallel.

12. The method of claim 10, wherein the end walls have differing radii of curvature and differently sized drill bits are used.

13. The method of claim 10, further comprising implanting the dental assembly in the eccentrically shaped opening.

14. The method of any of claim 9, further comprising implanting the dental assembly in the eccentrically shaped opening.
